(19) United States
(12) Patent Application Publication
(10) Pub. No.: US 2019/0188603 A1
(43) Pub. Date: Jun. 20, 2019

(54) WEAKLY-SUPERVISED FRAUD DETECTION FOR TRANSPORTATION SYSTEMS VIA MACHINE LEARNING

(71) Applicant: Uber Technologies, Inc., San Francisco, CA (US)

(72) Inventor: Fahrettin Olcay Cirit, San Francisco, CA (US)

(21) Appl. No.: 15/842,686

(22) Filed: Dec. 14, 2017

(51) Int. Cl. G06N 99/00; G06N 5/04; G06N 7/00

(52) U.S. Cl. CPC G06N 99/005; G06Q 50/30; G06N 7/00; G06N 5/046

(57) ABSTRACT

Example methods and systems disclosed herein train an accurate machine-learned model that detects fraud within an electronic transportation system. A first model is trained on a first (comparatively small) set of trip data items representing trips taken, or requested, in the electronic transportation system. The first set of trip data items have been manually labeled by human analysts to determine whether the trips were or were not fraudulent. The first model is used to generate weak labels for a second (comparatively larger) set of trip data items that lack manual labels. The weak labels are used along with the second set of trip data items to train a second model that is more accurate than the first model for detecting fraud.

### BACKGROUND

Electronic transportation systems aid users of the systems in arranging transportation (e.g., of human users, or of items to be delivered) from one location to another, hereinafter referred to as a “trip”. In some electronic transportation systems, amount earned by drivers increases as the number of the trips associated with those drivers also increases.

Some drivers may attempt to obtain additional earnings from the electronic transportation system with which they are affiliated by fraudulent means, such as by generating data indicating that they performed a trip on behalf of a customer, when in fact they did not do so. Thus, it is desirable for the electronic transportation systems to be able to identify driver fraud in order to avoid paying drivers for trips that were not in fact performed. However, manual review of all trip data is infeasible for most electronic transportation systems due to the sheer volume of data (e.g., there could be hundreds of thousands of trips in a given time frame). Additionally, manual review makes it infeasible to determine in real-time (or close to real-time), at the time that a trip is arranged or the trip is in progress, that the trip is likely fraudulent, given that manual review by human users typically takes significant time to complete.

### BRIEF DESCRIPTION OF DRAWINGS

FIG. 1 illustrates a detailed view of an environment in which users use their client devices to communicate with a server(s), such as to request transportation services, according to one embodiment.

FIG. 2 is a block diagram illustrating a detailed view of the fraud detection module of FIG. 1, according to one embodiment.

FIG. 3 illustrates the flow of data when training the discriminative model of FIG. 2, according to some embodiments.

FIG. 4 illustrates a data pipeline used for continuously refining the generative and discriminative models of FIG. 2 as the electronic transportation network's data evolves over time, according to some embodiments.

FIG. 4 is a sequence diagram illustrating the interactions taking place as part of the overall process of determining routes that take safety into account, according to one embodiment.

FIG. 5 is a high-level block diagram illustrating physical components of a computer used as part or all of the server or client devices from FIG. 1, according to one embodiment.

The figures depict various embodiments for purposes of illustration only. One skilled in the art will readily recognize from the following description that alternative embodiments of the structures and methods illustrated herein may be employed without departing from the examples described herein.

### DETAILED DESCRIPTION

Example methods and systems disclosed herein train an accurate machine-learned model that detects fraud within an electronic transportation system. A first model is trained on a first (comparatively small) set of trip data items representing trips taken, or requested, in the electronic transportation system. The first set of trip data items have been manually labeled by human analysts to determine whether the trips were or were not fraudulent. The first model is used to generate weak labels for a second (comparatively larger) set of trip data items that lack manual labels. The weak labels are used along with the second set of trip data items to train a second model that is more accurate than the first model for detecting fraud.

The human analysts may also derive fraud rules, e.g., based upon their prior analyses of the fraudulence of trip data items. These fraud rules, although suffering from various limitations, do nonetheless provide additional domain knowledge about fraud. In some embodiments, the fraud rules are applied to trip data items when training the first and second models, and the rule output values serve as additional input for the training.

In some embodiments, the training takes place repeatedly over time, as the trip data items for new trips are received and analyzed by human analysts. The feedback from the repeated training results in continual improvement in the accuracy of the models.

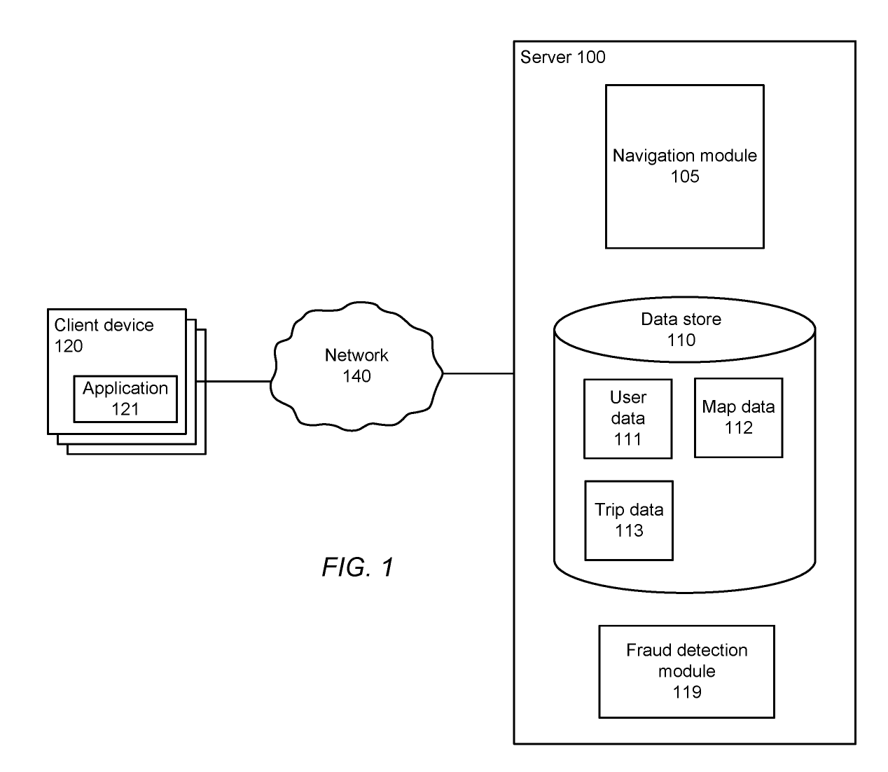

FIG. 1 illustrates a detailed view of an environment in which users use their client devices 120 to communicate with a server(s) 100, such as to request transportation services, according to one embodiment. For example, the server 100 can provide a network service to enable users to request location-based services using their respective designated client applications, such as to obtain transportation to a particular destination. The server 100 can process the requests to identify service providers to provide the requested services for the users.

The client device 120 can correspond to a computing device, such as a smart phone, tablet computer, laptop, or any other device that can communicate over the network 140 with the server(s) 100. In the embodiment illustrated in FIG. 1, the client devices 120 include an application 121 that the users of the client devices use to interact with the server 100, e.g., to provide location data and queries to the server 100, to receive map-related data and/or directions from the server, and the like. In one embodiment, the application 121 is created and made available by the same organization responsible for the server 100. Alternatively, in another example, the application 121 can be a third-party application that includes features (e.g., an application programming interface or software development kit) that enables communications with the server 100.

The network 140 may be any suitable communications network for data transmission. In an embodiment such as that illustrated in FIG. 1, the network 140 uses standard communications technologies and/or protocols and can include the Internet. In another embodiment, the entities use custom and/or dedicated data communications technologies.

The server 100 comprises a navigation module 105, a data store 110, and a fraud detection module 105. The navigation module 105 facilitates the transportation of one user (hereinafter referred to as the rider)—or of physical objects, such as groceries, packages, or the like—by a second user (hereinafter referred to as the driver) from a first location (hereinafter referred to as the pickup location) to a second location (hereinafter referred to as the destination location, or simply the destination), such as by providing map and/or navigation instructions to the respective client application of the driver. In one example, the server 100 can include a matching service (not illustrated in FIG. 1 for purposes of simplicity) that facilitates a rider requesting a trip from a pickup location to a destination location, and further facilitates a driver agreeing to provide the trip to the rider. For example, the matching service interacts with the applications 121 of the rider and a selected driver, establishes a trip for the rider to be transported from the pickup location and the destination location, and handles payment to be made by the rider to the driver. Additionally, in one embodiment, the navigation module 105 interacts with at least the application 121 of the driver during the trip, obtaining trip location information from the application (e.g., via Global Positioning System (GPS) or other geolocation coordinates) and providing navigation directions to the application that aid the driver in traveling from the driver's current location to the specified destination of the trip. The navigation module 105 may also facilitate a driver navigating to or obtaining information about a particular location, regardless of whether the driver has a rider, such as permitting the driver to navigate to a particular gas station, to an area of high demand for drivers, or to the pickup location of a rider.

The data store 110 can comprise one or more memory resources coupled to or accessible by the server 100. The data store 110 stores various types of data that the navigation module 105 uses to provide navigation services and otherwise facilitate transportation. More specifically, the data store 110 includes user data 111, which includes information on the registered users of the system, such as drivers and riders. The information may include, for example, user name, password, full name, home address, billing information, prior trips taken by the user, and the like.

The data store 110 further includes map data 112. The map data 112 include the information used to calculate routes, to render graphical maps, and the like. For example, the map data 112 include elements such as intersections and the roads connecting them, bridges, off-ramps, buildings, and the like, along with their associated locations (e.g., as geo-coordinates). In some embodiments the map data 112 also includes data about the “road segments”—the portions of the roads that connect the various pairs of map points such as intersections. The road segments may have associated data, such as road segment distance, the typical time to traverse a road segment from the point on one side of the segment to the point on the other, and the like.

The data store further includes trip data 113, with the data for a trip being referred to as a “trip data item” for that trip. In some embodiments, trip data items include data on the drivers of the trips, such as a rating, report, or comments given to or about the driver by the rider, and data related to the trip times, locations, or manner of driving, such as the starting time, ending time, starting location, ending location, cost, duration, total distance, and/or a list of locations (e.g., road segment IDs) that the trip passed through and the times at which they were reached, and/or sensor data such as acceleration, speed, or sequences of geolocation coordinates constituting the trip route. The trip data items may also include information about the riders (if any), such as their email addresses, usernames, or other identifying information, their rider ratings, etc.

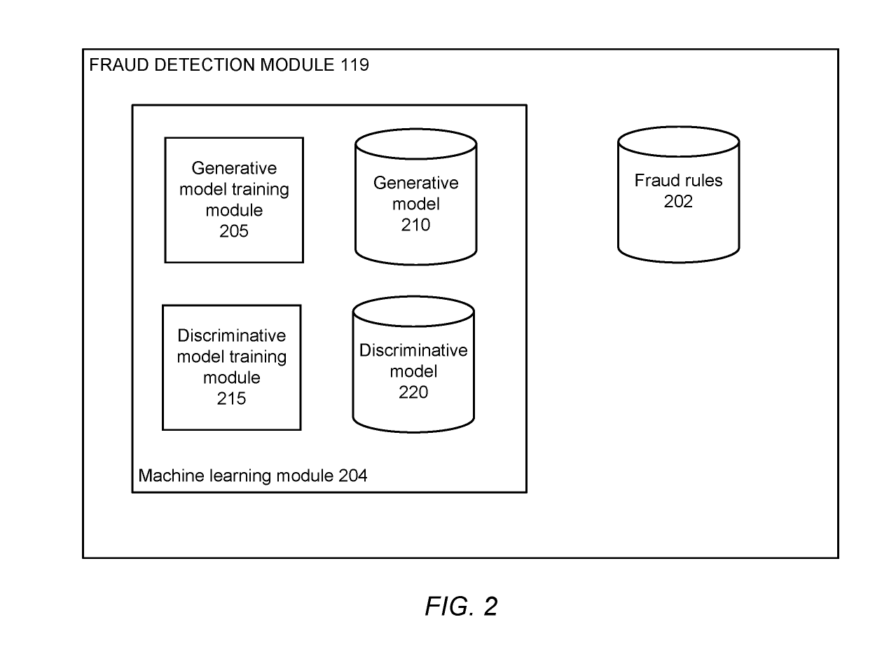

The fraud detection module 119 determines, for a given trip, whether that trip likely is fraudulent. In some embodiments, the fraud detection module 119 additional includes functionality to train the models that the fraud detection module uses to identify fraudulent trips. The fraud detection module 119 is described below in additional detail with respect to FIG. 2.

It is appreciated that the various types of data of FIG. 1 may be stored in any manner. For example, though the various data 111-113 are illustrated as being distinct, they might be included within the same database, file, or other storage unit. Furthermore, although the data 111-113 are described above as including particular types of data, it will however be appreciated that each of the types of data can be included in any one or more of the data 111-113 in alternative embodiments.

Although for simplicity only one server 100 and several client devices 120 are illustrated in the environment FIG. 1, it is appreciated that there may be any number of both client devices 120 and servers 100 within the environment.

FIG. 2 is a block diagram illustrating a detailed view of the fraud detection module 119 of FIG. 1, according to one embodiment.

In some embodiments, the fraud detection module 119 stores fraud rules 202. The fraud rules 202 are data and/or code constituting rules that the fraud detection module 119 applies to trip data items to predict whether the corresponding trips are fraudulent. The fraud rules 202 are authored by human analysts based upon their experience and observation of prior trip data. The fraud rules 202 may be expressed as Boolean combinations of other variables stored as part of the trip data items, or inferable therefrom. For example, a human analyst might determine that if the current rider and driver have been together on many previous trips, and the area in which the trips are taking place is an urban area in which there are many drivers (such that it is improbable that the same rider and driver would tend to co-occur), it is likely that the current trip is fraudulent. The fraud rules 202 may include any number of such rules, such as hundreds or thousands.

Manually authored rules such as those of the fraud rules 202 may have certain shortcomings, however. For example, as soon as the existence of a particular rule is discovered or guessed by users wishing to commit fraud, those users will change their approaches, rendering the rule of comparatively little value. As another example, rules that are highly accurate in one context may be inaccurate in other contexts, such as a rule that is accurate within a densely populated urban area but inaccurate in a more sparsely populated rural area. As yet another example, the rules may be narrowly tailored to address particular outbreaks of fraud, rather than being generally applicable. Thus, even when fraud rules 202 are available, it is beneficial to obtain more precise and generally-applicable models for identifying fraud that do not suffer from the shortcomings of the rules.

Accordingly, the fraud detection module 119 includes a machine learning module 204 that applies—and in some embodiments also generates—models capable of identifying transportation fraud with more generality and precision than the rules 202 alone are capable of.

In embodiments in which the machine learning module 204 of the fraud detection module 119 trains the models used for fraud detection, a two-step training processes is employed. Specifically, a generative training module 205 trains a generative model 210 from a set of trip data items that have been authoritatively labeled (e.g., by human analysts) as representing or not representing fraud. The generative model 210 is applied to a larger set of trip data items for which fraud labels have not yet been authoritatively determined, and the resulting outputs of the generative model for the larger set of trip data items are used as input to a discriminative model training module 215, which generates a discriminative model 220 that is more accurate than the generative model 210.

The generative model training module 205 takes as input a positive training set of trip data items already determined to constitute fraud based upon analyst reviews. In some embodiments, the generative model training module 205 additionally takes as input a negative training set of trip data items assumed to be non-fraudulent. For example, in some embodiments trip data items corresponding to trips made on behalf of established business partners of the electronic transportation system are assumed to be non-fraudulent, given the incentive to maintain the integrity of the relationship.

As previously discussed, the trip data items include intrinsic information such as information on the driver, information on the rider(s) (if any), information on methods of payment, sensor data such as acceleration and/or speed or a sequence of geolocation coordinates constituting the trip route, and the like.

In some embodiments, the trip data items also include values obtained by applying the fraud rules 202 to each of the data items. Thus, for each trip data item, there is one value for each of the fraud rules 202, such as a Boolean value indicating whether or not that fraud rule is met for that trip data item. Although the fraud rules 202 have the above-discussed limitations, they nonetheless constitute an additional useful source of information when training the generative model 210.

In some embodiments, the generative model 210 is trained using a neural network trained via stochastic gradient descent.

The generative model training module 205 takes the trip data items (e.g., both the intrinsic information and the values of the fraud rules 202) as input and outputs the generative model 210. The generative model 210, when applied to a trip data item, produces as output a score indicating whether or not the trip data item is fraudulent, such as a real number indicating a probability (or some function thereof) of fraudulence.

In some embodiments, rather than outputting a single score indicating generalized fraudulence, the generative model 210 outputs a score for each of some predetermined set of possible fraud types, such as credit card fraud, stolen account fraud, or the like; such embodiments additionally require that the trip data items input by the generative model training module 205 have a given label for each of the possible fraud types.

The scores output by the generative model 210 for trip data items may be considered weak labels, in the sense that they are analogous to authoritative labels manually applied by human analysts, though they are automatically derived and are of lower accuracy in most cases.

A discriminative model training module 215 takes as input a set of trip data items that have not been manually labeled by human analysts. Because manual labels need not be determined, it is feasible to use a much larger set of trip data items than that used to train the generative model 210. The discriminative model training module 215 obtains a set of weak labels corresponding to the input trip data items by applying the generative model 210 to each of the trip data items; these weak labels play the role of the manual labels used in training the generative model 210, although they have lesser reliability.

The discriminative model training module 215 takes as input the weak labels obtained from its input set of trip data items, along with other data associated with the trip data items, such as the intrinsic information of the trip data items and the values of the fraud rules 202 when applied to the trip data items, and outputs the discriminative model 220. The discriminative model 220, like the generative model 210, when applied to a trip data item produces as output a score indicating whether or not the trip data item is fraudulent. However, the score generated by the discriminative model 220 is typically more accurate than that generated by the generative model 210. One reason for the improved accuracy of the discriminative model 220 relative to the generative module 210 is that the discriminative model is trained on a larger set of trip data items than the generative model. Another reason is that the generative model 210 depends more for its accuracy upon the output of the fraud rules 202 than does the discriminative model 220, and the fraud rules are largely incapable of leveraging the data represented by trip data (such as sensor data and other comparatively opaque data) that do not readily lend themselves to being captured in the form of human-made rules. In contrast, the discriminative model 220 can better assimilate sensor data and other such data using the guidance provided by the weak labels produced by the generative model 210.

In some embodiments, the discriminative model 220 is trained using a neural network trained via stochastic gradient descent.

In some embodiments, the fraud detection module 119 of the server 100 does not itself train the models 210, 220, but rather obtains them from some other system that has previously trained them.

With the discriminative model 220 trained, the fraud detection module 119 can use the discriminative model in various ways to identify and combat fraud. For example, when a trip is first requested but has not yet begun, the fraud detection module 119 can be applied in real time to determine the probability that the requested trip is fraudulent, rejecting the trip before it begins. As another example, the fraud detection module 119 can be used to rank drivers according to their apparent trustworthiness. For instance, the fraud detection module 119 can filter, for each driver, the trip data 113 to obtain the trips conducted by that driver, and obtain an average or other aggregate function of the scores produced by the discriminative model 220, with high fraud scores indicating low trustworthiness. The drivers can then be ranked according to their average scores, and the server 100 can take appropriate actions, such as investigating drivers with particularly low trustworthiness, excluding, or ranking lower, drivers of low trustworthiness when arranging trips, or the like.

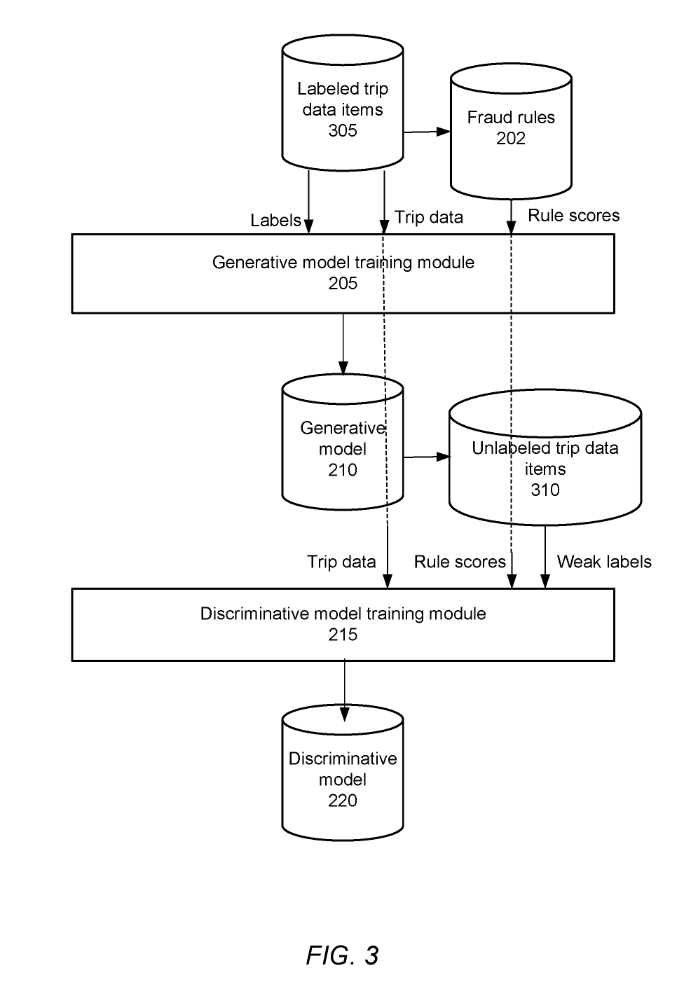

FIG. 3 illustrates the flow of data when training the discriminative model 220, according to some embodiments. The generative model training module 205 uses a (comparatively smaller) set of trip data items 305 with manual labels specified by human analysts, taking as input the data associated with the trip data items, such as the intrinsic trip data, and the values obtained from the trip data items by applying the fraud rules 202, as well as the manual labels. The output of the generative model training module 205 is the generative model 210.

The discriminative model training module 215 uses a (comparatively larger) set of trip data items 310 lacking manual labels specified by human analysts, taking as input the data associated with the trip data items, such as the intrinsic trip data, and the values obtained from the trip data items by applying the fraud rules 202. Since the larger set of trip data items lacks manual labels, the discriminative model training module 215 approximates such manual labels by applying the generative model 210 to the larger set of trip data items to obtain weak labels, which act as a proxy for the manual labels. The output of the discriminative model training module 215 is the discriminative model 220.

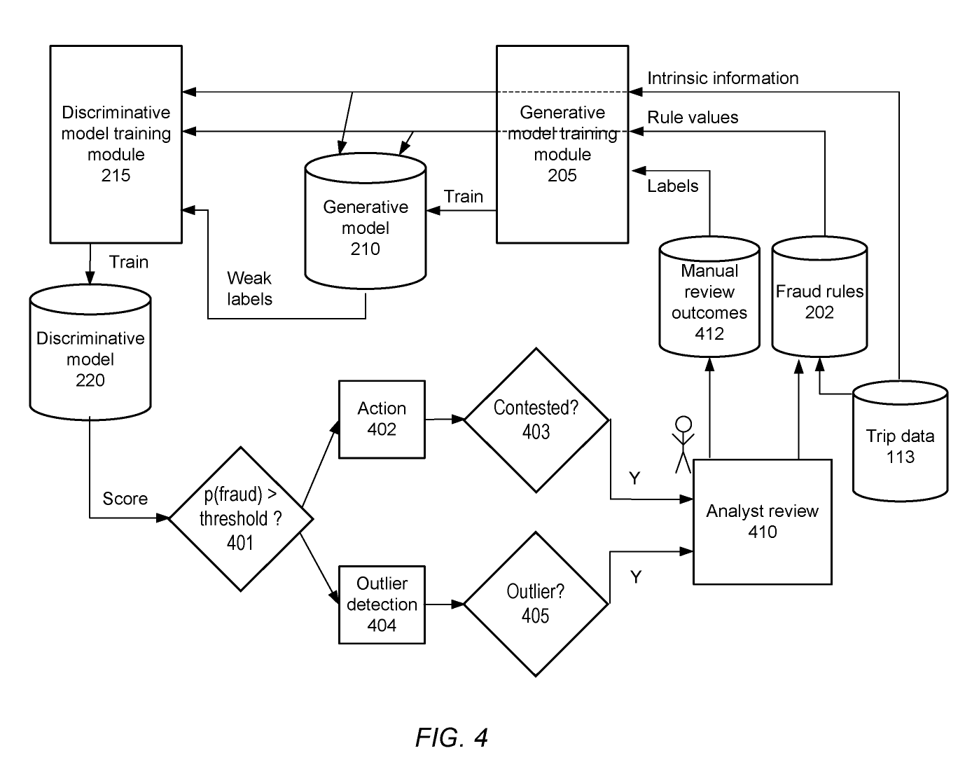

FIG. 4 illustrates a data pipeline or process used for continuously refining the generative and discriminative models 210, 220 as the electronic transportation network's data evolves over time, according to some embodiments.

At step 401, the trip data item for a particular trip is evaluated to determine whether it is probable that the trip is fraudulent. Initially, before the generative or discriminative models 210, 220 have been trained, this determination can be made by applying the fraud rules 202 to the trip data item; after the models have been trained, the determination is made by applying the discriminative model 220 to the trip data item and determining whether the resulting score is greater than a threshold value, e.g., a probability greater than 0.99.

If the determination of step 401 is that the trip is probably fraudulent, an action 402 is taken, such as declining to provide payment to the driver of the trip, investigating the driver, or the like. If the action is not contested (e.g., by the driver), the trip data item is labeled as being fraudulent. If the action is contested, the trip data item is provided to an analyst review process 410.

The determination of step 401 is the trip is probably non-fraudulent, the trip data item may nonetheless be analyzed by an automated outlier detection step 404, which determines whether the trip data item is anomalous in a given way, such as that the driver of the trip has been earning an unusually large amount of money over some recent time period. If the trip data item is determined to be an outlier, is provided to the analyst review process 410.

The analyst review process 410 is carried out by human analysts of the electronic transportation system. The analysts analyze the trip data items according to their domain knowledge and experience, manually labeling the trip data items as being fraudulent or non-fraudulent as a result of their analysis. The trip data items (or identifier thereof) are stored along with the determined manual labels in a manual review outcomes store 412. Additionally, the human analysts may create additional fraud rules 202 as a result of their analyses, thereby contributing to the ability to identify fraud.

The generative model training module 205 uses this information to train the generative model 210 based on previously-considered trip data items. In some embodiments, the set of all previous labeled trips is used as input to the training, including those labeled in any prior iteration of training; in other embodiments, only more recently-labeled trips are used, such as those from some number of the most recent iterations. Specifically, the generative model training module 205 accepts as input for the trip data items: the labels from the manual review outcomes 412 (possibly along with other labels, such as inferred labels of non-fraudulence for trip data items associated with trusted business partners), the values for the fraud rules 202, and the intrinsic information. The trip data item input may be grouped into positive and negative training sets, based on the labels from the manual review outcomes.

The discriminative model training module 215 uses the generative model 210 to produce weak labels from a larger set of the trip data items stored in the trip data 113. Those weak labels, along with the intrinsic information and the rule values from the trip data items of the larger set serve as input from which the discriminative model training module 215 trains the discriminative model 220.

After the discriminative model 220 is trained, it is used to produce scores for trip data items indicating how likely it is that the trip data items are fraudulent. These scores may be used in step 401 for subsequent iterations of training. In some embodiments, the discriminative model 220 is applied only to trips from a particular historical window, such as the trips from the most recent N days, for some integer N.

Although the discussion above has focused on fraud detection for trips in a transportation system, the described use of weak labels obtained from a generative model and the associated training of a discriminative model are applicable to other types of problems in other industries, as well, such as the problems of credit card fraud, intrusion detection, malware detection, and identity theft, in industries such as gaming, banking, security, and surveillance. As one example from the finance/banking industry, credit card fraud can be detected by training a generative model based on the intrinsic features of a first set of credit card transactions, labeled by human fraud analysts as being fraudulent (or not), possibly including features derived from a set of credit card fraud rules created by the human fraud analysts. The discriminative model can then be trained by applying the generative model to a larger (unlabeled) set of credit card transactions, thereby obtaining weak labels that can be used in the training of the discriminative model. As another example, from the computer security industry, malware may be detected by training a generative and a discriminative model that determine whether a given portion of code is malware or not. A generative model can be trained based on the intrinsic features of a first set of code portions, labeled by human malware analysts as being malware (or not), possibly including features derived from a set of malware-detection rules created by the human security analysts. The discriminative model can then be trained by applying the generative model to a larger (unlabeled) set of code portions, thereby obtaining weak labels that can be used in the training of the discriminative model.

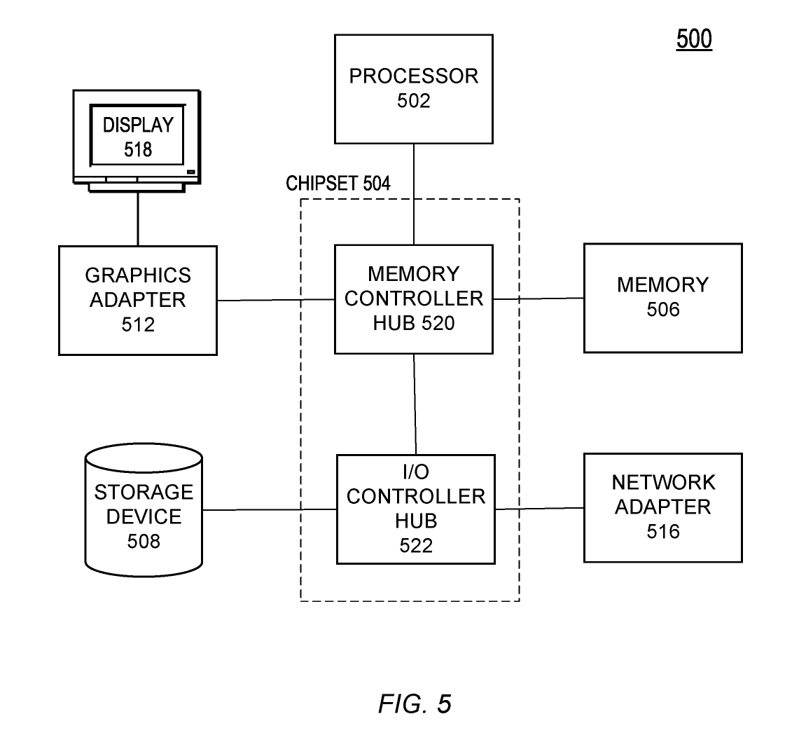

FIG. 5 is a high-level block diagram illustrating physical components of a computer 500 used as part or all of the server 100 or client devices 120 from FIG. 1, according to one embodiment. Illustrated are at least one processor 502 coupled to a chipset 504. Also coupled to the chipset 504 are a memory 506, a storage device 508, a graphics adapter 512, and a network adapter 516. A display 518 is coupled to the graphics adapter 512. In one embodiment, the functionality of the chipset 504 is provided by a memory controller hub 520 and an I/O controller hub 522. In another embodiment, the memory 506 is coupled directly to the processor 502 instead of the chipset 504.

The storage device 508 is any non-transitory computer-readable storage medium, such as a hard drive, compact disk read-only memory (CD-ROM), DVD, or a solid-state memory device. The memory 506 holds instructions and data used by the processor 502. The graphics adapter 512 displays images and other information on the display 518. The network adapter 516 couples the computer 500 to a local or wide area network.

As is known in the art, a computer 500 can have different and/or other components than those shown in FIG. 5. In addition, the computer 500 can lack certain illustrated components. In one embodiment, a computer 500 such as a server or smartphone may lack a graphics adapter 512, and/or display 518, as well as a keyboard or pointing device. Moreover, the storage device 508 can be local and/or remote from the computer 500 (such as embodied within a storage area network (SAN)).

As is known in the art, the computer 500 is adapted to execute computer program modules for providing functionality described herein. As used herein, the term “module” refers to computer program logic utilized to provide the specified functionality. Thus, a module can be implemented in hardware, firmware, and/or software. In one embodiment, program modules are stored on the storage device 508, loaded into the memory 506, and executed by the processor 502.

Embodiments of the entities described herein can include other and/or different modules than the ones described here. In addition, the functionality attributed to the modules can be performed by other or different modules in other embodiments. Moreover, this description occasionally omits the term “module” for purposes of clarity and convenience.

The present invention has been described in particular detail with respect to one possible embodiment. Those of skill in the art will appreciate that the invention may be practiced in other embodiments. First, the particular naming of the components and variables, capitalization of terms, the attributes, data structures, or any other programming or structural aspect is not mandatory or significant, and the mechanisms that implement the invention or its features may have different names, formats, or protocols. Also, the particular division of functionality between the various system components described herein is merely for purposes of example, and is not mandatory; functions performed by a single system component may instead be performed by multiple components, and functions performed by multiple components may instead performed by a single component.

Some portions of above description present the features of the present invention in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by real time network operating systems.

The present invention also relates to an apparatus for performing the operations herein. This apparatus may be specially constructed for the required purposes, or it may comprise a general-purpose computer selectively activated or reconfigured by a computer program stored on a computer readable medium that can be accessed by the computer. Such a computer program may be stored in a non-transitory computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of computer-readable storage medium suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, the present invention is not described with reference to any particular programming language. It is appreciated that a variety of programming languages may be used to implement the teachings of the present invention as described herein, and any references to specific languages are provided for invention of enablement and best mode of the present invention.

The present invention is well suited to a wide variety of computer network systems over numerous topologies. Within this field, the configuration and management of large networks comprise storage devices and computers that are communicatively coupled to dissimilar computers and storage devices over a network, such as the Internet.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the following claims.

What is claimed is:

1. A computer-implemented method for detecting fraudulent trips within an electronic transportation system, the computer-implemented method comprising:
training a generative model from a first set of trip data items representing a corresponding first set of trips, the trip data items having manual labels indicating whether the corresponding trips are fraudulent;
obtaining a set of weak labels for a corresponding second set of trip data items representing a corresponding second set of trips by applying the generative model to the second set of trip data items, the second set of trip data items comprising more trip data items than the first set of trip data items and lacking manual labels indicating whether the second set of trips are fraudulent, the set of weak labels indicating probabilities that the second set of trips are fraudulent;
training a discriminative model from the second set of trip data items and the set of weak labels; and
obtaining a fraud score for a trip data item representing a requested trip that has not begun, by applying the discriminative model to the trip data item.

2. The computer-implemented method of claim 1, further comprising grouping the first set of trip data items into a positive training set and a negative training set based on the manual labels.

3. The computer-implemented method of claim 1, further comprising:
applying fraud rules to the first set of trip data items to obtain corresponding fraud values;
wherein the generative model is trained at least in part based on the fraud values.

4. The computer-implemented method of claim 3, further comprising:
obtaining additional trip data items;
obtaining additional fraud rules specified by data analysts;
applying the additional fraud rules to a third set of trip data items to obtain corresponding additional fraud values; and
re-training the generative model and the discriminative model based, at least in part, on the additional fraud values.

5. The computer-implemented method of claim 1, wherein the trip data items include at least one of: information about drivers of the trips, information about riders of the trips, times of the trips, locations of the trips, or sensor data from client devices used on the trips.

6. The computer-implemented method of claim 1, further comprising providing the trip data item to an analyst review process responsive to the fraud score being greater than a threshold.

7. The computer-implemented method of claim 6, further comprising:
obtaining a manual label for the trip data item from a human analyst; and
using the manual label and the trip data item to re-train the generative model.

8. A non-transitory computer-readable storage medium storing instructions that when executed by a computer processor perform actions comprising:
training a generative model from a first set of trip data items representing a corresponding first set of trips, the trip data items having manual labels indicating whether the corresponding trips are fraudulent;
obtaining a set of weak labels for a corresponding second set of trip data items representing a corresponding second set of trips by applying the generative model to the second set of trip data items, the second set of trip data items comprising more trip data items than the first set of trip data items and lacking manual labels indicating whether the second set of trips are fraudulent, the set of weak labels indicating probabilities that the second set of trips are fraudulent;
training a discriminative model from the second set of trip data items and the set of weak labels; and
obtaining a fraud score for a trip data item representing a requested trip that has not begun, by applying the discriminative model to the trip data item.

9. The non-transitory computer-readable storage medium of claim 8, the actions further comprising grouping the first set of trip data items into a positive training set and a negative training set based on the manual labels.

10. The non-transitory computer-readable storage medium of claim 8, the actions further comprising:
applying fraud rules to the first set of trip data items to obtain corresponding fraud values;
wherein the generative model is trained at least in part based on the fraud values.

11. The non-transitory computer-readable storage medium of claim 10, the actions further comprising:
obtaining additional trip data items;
obtaining additional fraud rules specified by data analysts;
applying the additional fraud rules to a third set of trip data items to obtain corresponding additional fraud values; and
re-training the generative model and the discriminative model based, at least in part, on the additional fraud values.

12. The non-transitory computer-readable storage medium of claim 8, wherein the trip data items include at least one of: information about drivers of the trips, information about riders of the trips, times of the trips, locations of the trips, or sensor data from client devices used on the trips.

13. The non-transitory computer-readable storage medium of claim 8, the actions further comprising providing the trip data item to an analyst review process responsive to the fraud score being greater than a threshold.

14. The non-transitory computer-readable storage medium of claim 13, the actions further comprising:
obtaining a manual label for the trip data item from a human analyst; and
using the manual label and the trip data item to re-train the generative model.

15. A computer system comprising:
a computer processor; and
a non-transitory computer-readable storage medium storing instructions that when executed by a computer processor perform actions comprising:
training a generative model from a first set of trip data items representing a corresponding first set of trips, the trip data items having manual labels indicating whether the corresponding trips are fraudulent;
obtaining a set of weak labels for a corresponding second set of trip data items representing a corresponding second set of trips by applying the generative model to the second set of trip data items, the second set of trip data items comprising more trip data items than the first set of trip data items and lacking manual labels indicating whether the second set of trips are fraudulent, the set of weak labels indicating probabilities that the second set of trips are fraudulent;
training a discriminative model from the second set of trip data items and the set of weak labels; and
obtaining a fraud score for a trip data item representing a requested trip that has not begun, by applying the discriminative model to the trip data item.

16. The computer system of claim 15, the actions further comprising grouping the first set of trip data items into a positive training set and a negative training set based on the manual labels.

17. The computer system of claim 15, the actions further comprising:
applying fraud rules to the first set of trip data items to obtain corresponding fraud values;
wherein the generative model is trained at least in part based on the fraud values.

18. The computer system of claim 17, the actions further comprising:
obtaining additional trip data items;
obtaining additional fraud rules specified by data analysts;
applying the additional fraud rules to a third set of trip data items to obtain corresponding additional fraud values; and
re-training the generative model and the discriminative model based, at least in part, on the additional fraud values.

19. The computer system of claim 15, wherein the trip data items include at least one of: information about drivers of the trips, information about riders of the trips, times of the trips, locations of the trips, or sensor data from client devices used on the trips.

20. The computer system of claim 15, the actions further comprising providing the trip data item to an analyst review process responsive to the fraud score being greater than a threshold.
